(19) United States
(12) Patent Application Publication
(10) Pub. No.: US 2015/0128390 A1
(43) Pub. Date: May 14, 2015

(54) Container for a Cemetery Mausoleum for inurnment of Cremated Remains and designed to occupy a cavity between a sealed Crypt and its decorative facing.

(71) Applicant: Stephen John Gee, Chelsea (CA)

(72) Inventor: Stephen John Gee, Chelsea (CA)

(21) Appl. No.: 14/080,118

(22) Filed: Nov. 14, 2013

(51) Int. Cl. A61G 17/08

(52) U.S. Cl. CPC A61G 17/08
USPC 27/1

(57) ABSTRACT

This inurnment container (urn) for cremated remains is designed for use in a Cemetery Mausoleum and to occupy the cavity between a sealed Crypt and its decorative facing. The depth of this container and the design to fit the limited available space within the cavity will allow the use of previously unutilized space for the interment of the cremated remains immediately adjacent to an occupied Crypt without the necessity of disturbing the sealed Crypt.

The instant application is a CIP Application of application Ser. No. 13/517,700 and filed Jun. 14, 2012 Confirmation No. 5100

### SUGGESTED CLASSIFICATION

Cremation Urn.

### TOTAL NUMBER OF DRAWING SHEETS INCLUDED

Two. (Pages 10 and 11).

### FOREIGN PRIORITY INFORMATION

Filing priority is claimed by virtue of Filing Application No. 2,769,135 dated 2012 Feb. 17 with:

Patent Office, Canadian Intellectual Property Office,

Industry Canada, Government of Canada,

Place du Portage, Room C-229, 2^{nd} Floor, 50 Victoria Street,

Gatineau, Quebec, Canada K1A 0C9

A certified copy of the Foreign Application was included with the Amending Submission dated Apr. 5, 2013, as directed.

### FOREIGN PRIORITY INFORMATION

Filing priority is claimed by virtue of Filing Application No. 2,769,135 dated 2012 Feb. 17 with:

Patent Office, Canadian Intellectual Property Office,

Industry Canada, Government of Canada,

Place du Portage, Room C-229, 2^{nd} Floor, 50 Victoria Street,

Gatineau, Quebec, Canada K1A 0C9

A certified copy of the Foreign Application was included with the Amending Submission dated Apr. 5, 2013, as directed.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OR THE PARTIES TO A JOINT RESEARCH AGREEMENT

Not applicable.

### BACKGROUND OF THE INVENTION

### Field of the Invention

### Background Information

Mausoleum: A burial place containing Crypts for the bodies or remains of individuals, usually in the form of a building. In recent years, Mausoleum buildings have tended to become larger incorporating many Crypts and can also include Columbarium's. A common decorative feature of Mausolea is they are clad with marble or granite veneer facings which cover Crypt fronts, Columbaria fronts and blank walls.

Crypt: A chamber or vault within a mausoleum for placement or storage of a body or remains of an individual, typically contained within a casket or coffin, and which can be hermetically sealed.

Crypt Shutter: The marble or granite decorative veneer facing in front of a Crypt and typically inscribed with information concerning the deceased individual(s) interred within the Crypt. Behind the Crypt Shutter and in front of the sealed Crypt can be an adjustment space of approximately 2″ in depth.

Columbarium: A structure with recessed niches within the walls to receive Cremation Urns containing the cremated ashes of the dead. Facing is typically granite or marble, but can also be glass to permit viewing of the Cremation Urn.

Cremation Urn: A container for holding the cremated remains of the dead.

Cemeteries are facing requests from bereaved families to open sealed Mausoleum Crypts, to add a Cremation Urn holding cremated remains. Complying with the request can be difficult˜the design of this invention addresses and resolves the problems and offers a new interment option for cremated remains.

With changing burial practices, cremation rates have increased and many cremated remains are interred separately in Columbaria or in-ground. However, some families are requesting that a container holding cremated remains be added to a Mausoleum Crypt in which a family member has previously been interred. Available space within an occupied Crypt can be problematic, as can be the condition of the casket already occupying the Crypt.

This container for cremated remains is uniquely designed to occupy an existing cavity between the sealed Crypt and its Crypt Shutter (decorative facing), thus avoiding the necessity of disturbing the sealed Crypt. It also offers a new interment option for cremated remains.

### Description of Related Art

Typical prior art storage systems for holding cremated remains may be seen in the Hancovsky patent, U.S. Pat. No. 4,607,417; the See patent, U.S. Pat. No. 4,688,359; the Eickhof, U.S. Pat. No. 5,195,812; the Schorman patent, U.S. Pat. No. 5,287,603; the Hunter patent, U.S. Pat. No. 617,161; the Diem patent, U.S. Pat. No. 3,183,574; the Pangburn et al. patent, U.S. Pat. No. 3,754,805; the Thompson patent, U.S. Pat. No. 3,529,730; the Pickel patent, U.S. Pat. No. 3,925,944; and the Neuberger et al. patent, U.S. Pat. No. 5,625,933.

The Neuberger et al. patent, U.S. Pat. No. 5,625,933, is a Cremation Urn.

Typically, Cremation Urns are placed within a Columbarium or buried in-ground. Neuberger et al. is a decorative Cremation Urn incorporating a mounting system which enables a plurality of identical Cremation Urns to hang together on the exterior of a blank wall, thereby creating a Columbarium like structure

The present application is for a Cremation Urn which, with its dimensions, minimal depth and simple hanging devise, is hidden within the wall of a Mausoleum behind a Crypt Shutter.

### BRIEF SUMMARY OF THE INVENTION

A Mausoleum container for cremated remains, comprised of a formed or moulded container of approximately 200 cubic inch capacity with a depth of 1½″, thereby enabling it to take advantage of the existing narrow, unutilized space that exists within the front wall of a Mausoleum Crypt between the sealed Crypt and its decorative facing or Crypt Shutter. It incorporates a hook like appendage to hang on the interior face of a Crypt Shutter which, when closed and permanently fastened, hides the urn from view.

### DETAILED DESCRIPTION OF THE INVENTION

Container for a Cemetery Mausoleum for inurnment of cremated remains and designed to occupy a cavity between a sealed Crypt and its decorative facing.

This invention is a storage container (urn) for cremated remains specifically shaped to occupy an existing cavity within the wall of a Crypt, between a sealed Crypt and its Crypt Shutter. It is designed to hang on the back of the Crypt Shutter, embedded within the wall and hidden between the sealed Crypt and its decorative facing (Crypt Shutter).

Dimensions are:

Overall height: 16½″

Height of containment canister: 15″

Overall width: 10″

Depth: 1½″

Hanger depth: 15/16″

Drawings with dimensions are provided with this application.

This Urn for Mausoleum Crypts is designed to have a capacity of approximately 200 cubic inches with a closable opening to admit cremated remains, and is formed with sheet metal or similar material.

### DESCRIPTION OF DRAWING VIEWS

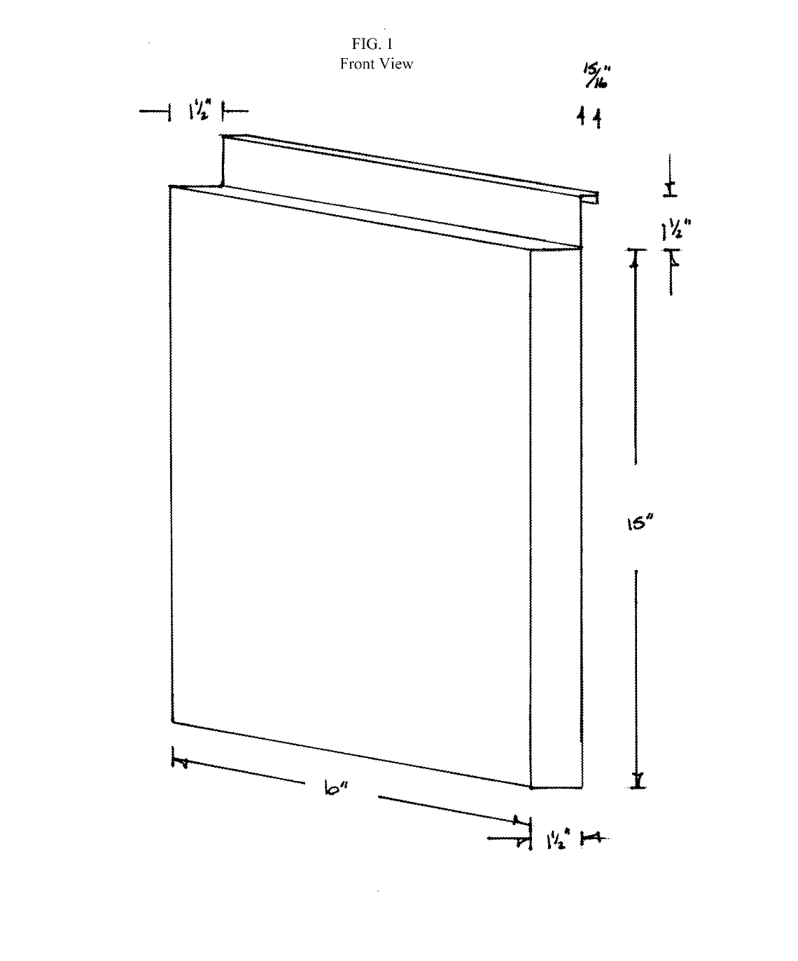

Page 10: FIG. 1˜Drawing 1 of 2˜Front view with dimensions (Front Page View).

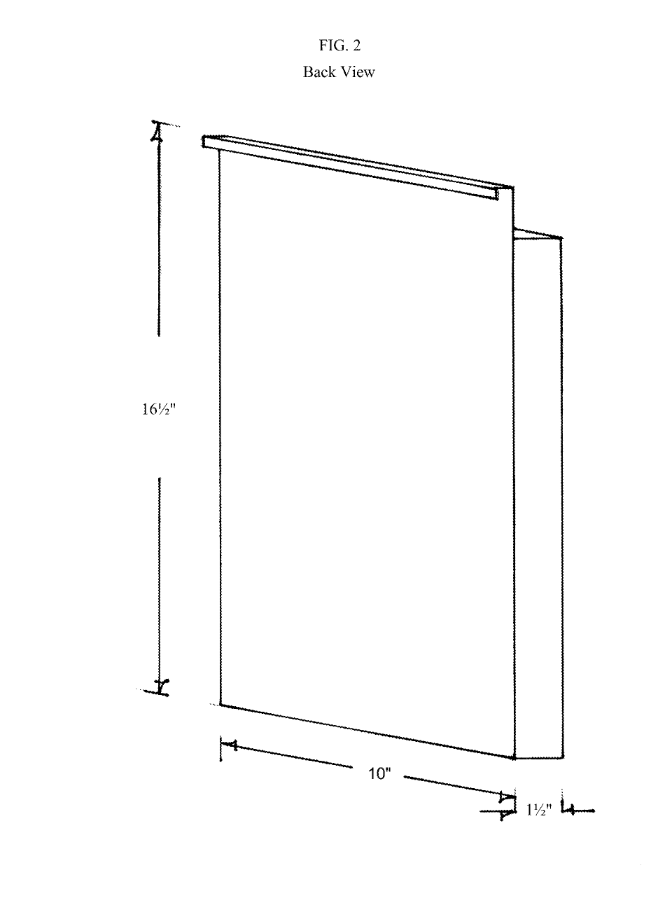

Page 11: FIG. 2˜Drawing 2 of 2˜Back view with dimensions.

The embodiments of the invention in which an exclusive property or privilege is claimed are defined as follows:

1. A Mausoleum container for cremated remains, comprised of a formed or moulded container of approximately 200 cubic inch capacity with a depth of 1½″. It incorporates a hook like appendage to enable it to hang on the interior face of a Crypt Shutter which, when closed and permanently fastened, hides the container from view

2. A container in accordance with claim (1) which will fit within the narrow confines of an available cavity that exists within the front wall of a Mausoleum Crypt, between the sealed Crypt and its decorative facing or Crypt Shutter.
